(19) United States
(12) Patent Application Publication
(10) Pub. No.: US 2016/0313483 A1
(43) Pub. Date: Oct. 27, 2016

(54) Cable Identifier

(71) Applicant: Bogdan Chomycz, Tecumseh (CA)

(72) Inventor: Bogdan Chomycz, Tecumseh (CA)

(21) Appl. No.: 14/696,145

(22) Filed: Apr. 24, 2015

(51) Int. Cl. F21V 8/00; G02B 6/44

(52) U.S. Cl. CPC G02B 6/001; G02B 6/447; G02B 6/4416

(57) ABSTRACT

A continuous length of side emitting optical fiber is secured to a cable's jacket or imbedded into the jacket along the cable's entire length. When a light source is coupled to one or both ends of the side emitting fiber its entire length lights up. This instantly identifies the entire cable length and enables the cable to be quickly and accurately located along the entire cable route.

Cables with side emitting fiber are installed and operated without light sources coupled to the cables. Light sources are only coupled to the cable's side emitting fiber when the cable needs to be identified.

Different colored light sources can be coupled to different side emitting fiber cables, which allow the identification of multiple cables at one time by color distinction.

The side emitting fiber can be secured to the cable in various patterns along the cable length.

### BACKGROUND OF THE INVENTION

Cables, such as electrical and communication cables, are placed throughout structures such as buildings during and after construction. It is often required to identify specific individual cables after cable placement for repair, replacement, upgrade or other reasons. If the cable route is short this may not be a difficult task and the cable can often be traced from one end to the other end. For long cable lengths, specially if the cable is bunched with other cables, it can be difficult to identify individual cables in a cable route. Often one must resort to the tedious and lengthy task of carefully and visually tracing the cable throughout the cable route. This technique is prone to error since it can be difficult or practically not possible to uncouple a group of cables and visually trace the specific cable among the other cables, which are often similar in appearance.

Side emitting optical fiber is a special type of optical fiber that allows a certain percentage of light, that is coupled to it, to pass out of the fiber into the environment along its length. It does not confine all of the light in its core like a regular optical fiber that is used for communications. When a light source is coupled to one or both ends of a side emitting fiber, some percentage of the light will escape out of the fiber and into the environment along the side emitting fiber's entire length. This will cause the side emitting fiber to light up along its entire length. When a side emitting optical fiber is attached to a cable's jacket along the cable's entire length, this feature is used to identify the location of the cable along its route. The side emitting fiber is totally passive and a dielectric and hence does not propagate electricity. The tracer side emitting fiber on a cable will not interfere with any electrical or optical characteristics of the cable itself since the side emitting fiber is a dielectric and the light in the side emitting fiber does not effect a cable's electric and magnetic fields.

### BRIEF SUMMARY OF THE INVENTION

A side emitting optical fiber is permanently attached to the outer cable jacket, or embedded into the outer cable jacket, along the cable's entire length. When the side emitting fiber is coupled to a proper light source at one or both ends, the side emitting fiber will light up along its entire length, which in turn identifies the cable along its length since it is attached to the side emitting fiber. This technique is used to quickly and simply identify the cable along its route. The light source is only coupled to the side emitting fiber when it is necessary to trace the cable. At other times, such as during cable installation and operation, the light source does not need to be coupled to the side emitting fiber.

This invention provides a unique, accurate, quick and easy way to identify individual cables along a cable route.

### BRIEF DESCRIPTION OF THE DRAWINGS

Example of the present invention is illustrated in the accompanying drawing. The accompanying drawing, however, does not limit the scope of the present invention.

FIG. 1 Cable with a parallel side emitting fiber coupled to a light source at one end.

FIG. 2 Cable with a helix wrap side emitting fiber coupled to a light source at one end.

### DETAILED DESCRIPTION OF THE INVENTION

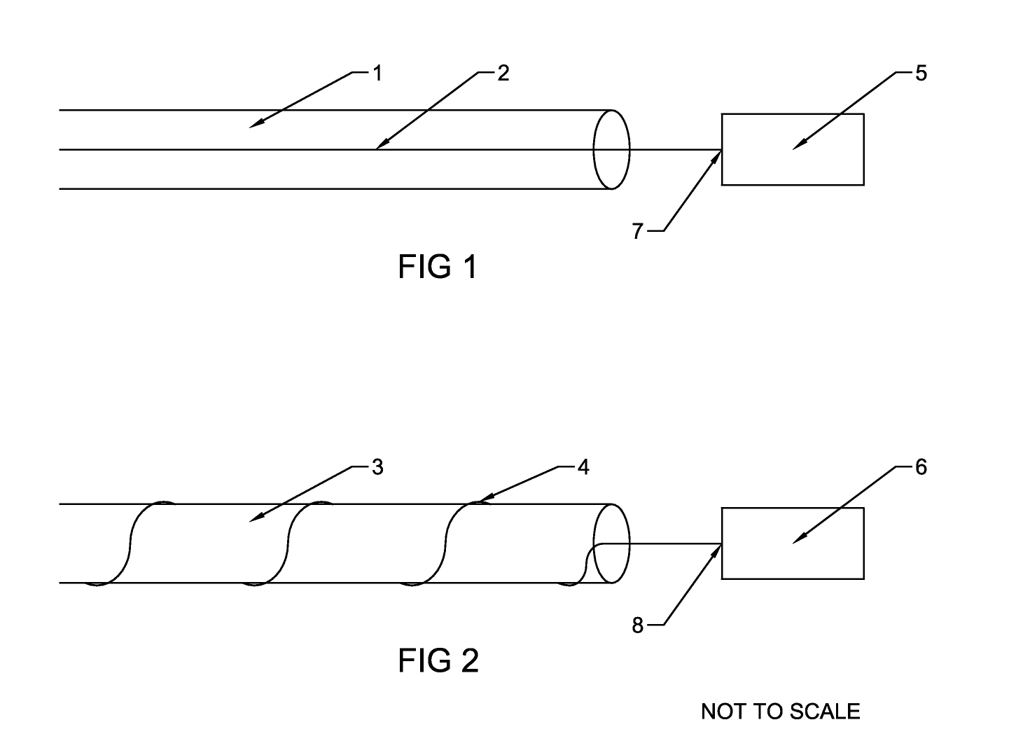

FIG. 1 shows the invention with the side emitting optical fiber (2) permanently attached to the outer jacket of the cable and is parallel to the cable's (1) axis. The cable (1) with its side emitting optical fiber (2) is installed into a cable pathway throughout a structure. The cable is used for its normal purpose. When a light source (5) is coupled (7) to the cable's side emitting fiber, it will illuminate the entire length of the side emitting fiber and hence identify the cable along its length.

FIG. 2 shows the invention with the side emitting optical fiber (4) permanently attached to the outer jacket of the cable and is would in a helix pattern along the cable (3). The cable (3) with its side emitting optical fiber (4) is installed into a cable pathway throughout a structure. The cable is used for its normal purpose. When a light source (6) is coupled (8) to the cable's side emitting fiber, it will illuminate the length of the side emitting fiber and hence identify the cable along its length.

This invention will result in a much quicker and simpler method of identifying and locating cables that are installed throughout a structure such as a building.

What is claimed is:

1. A continuous length of side emitting optical fiber is permanently attached, by any means, to the exterior of a cable's jacket along the cable's entire or partial length. The cable can also be manufactured with the continuous length of side emitting fiber embedded into the cable's jacket but still visible. The side emitting optical fiber is a special type of optical fiber that emits light along its length when a proper light source is coupled to one or both of its ends. The side emitting optical fiber can be any width, any diameter and made of any material that propagates light such as plastic or glass. Current technology side emitting fiber is round but it can also be any shape including rectangular or flat. The side emitting optical fiber on the cable can be referred to as a tracer optical fiber, tracer fiber, or tracer side emitting optical fiber. The cable that the side emitting optical fiber is attached to can be of any type of cable including electrical cable, communication cable and fiber optic cable. The cable can be any diameter, any size, any shape and any length.

2. For the invention in claim 1, the side emitting optical fiber is attached to the cable or embedded into the cable such that the center axis of the side emitting optical fiber is parallel to the cable's center axis, or the side emitting optical fiber is wrapped and secured to the cable in a helix pattern around the cable, or the side emitting optical fiber is secured to the cable in any other pattern along the cable's length.

3. For the invention in claim 1, a light source is coupled temporarily or permanently to one or both ends of the side emitting optical fiber such that light from the light source will be transmitted into the side emitting fiber. Once a light source is coupled to the side emitting fiber, the side emitting fiber will light up its entire length along the cable. A light source is only coupled to the side emitting optic fiber when the cable needs to be identified.

4. For the invention in claim 1, a light source of a specific color is coupled to one or both ends of the cable's side emitting fiber. This will allow the identification and tracing of multiple individual cables by the color of light emitted by each cable's side emitting fiber.
